(19) United States
(12) Patent Application Publication
(10) Pub. No.: US 2021/0365033 A1
(43) Pub. Date: Nov. 25, 2021

(54) MODEL PREDICTIVE CONTROL DEVICE, COMPUTER READABLE MEDIUM, MODEL PREDICTIVE CONTROL SYSTEM AND MODEL PREDICTIVE CONTROL METHOD

(71) Applicant: Mitsubishi Electric Corporation, Tokyo (JP)

(72) Inventors: Hidekazu SEGAWA, Tokyo (JP); Atsushi SETTSU, Tokyo (JP); Masakatsu TOYAMA, Tokyo (JP); Hiroki KONAKA, Tokyo (JP)

(73) Assignee: Mitsubishi Electric Corporation, Tokyo (JP)

(21) Appl. No.: 17/392,557

(22) Filed: Aug. 3, 2021

Related U.S. Application Data
(63) Continuation of application No. PCT/JP2019/014180, filed on Mar. 29, 2019.

(51) Int. Cl. G05D 1/02; G06N 3/04

(52) U.S. Cl. CPC G05D 1/0221; G06N 3/04

(57) ABSTRACT

An operation path generation unit (210) generates an operation quantity time series for an actuator (111) based on a measurement state quantity output from a state sensor (101). A predictive model unit (220) generates a state quantity predictive time series by calculating a predictive model by using as an input the measurement state quantity and the operation quantity time series. A neural network unit (230) corrects the state quantity predictive time series by performing arithmetic operation of a neural network, by using as an input a measurement environment quantity output from an environment sensor (102) and the state quantity predictive time series. A state quantity evaluation unit (240) generates an evaluation result for the state quantity time series after the correction. The operation path generation unit outputs an operation quantity at the head of the operation quantity time series to the actuator when the evaluation result fulfils an appropriate criterion.

### CROSS REFERENCE TO RELATED APPLICATIONS

This application is a Continuation of PCT international Application No. PCT/JP2019/014180 filed on Mar. 29, 2019, which is hereby expressly incorporated by reference into the present application.

### TECHNICAL FIELD

The present invention relates to model predictive control.

### BACKGROUND ART

It is known model predictive control to control a controlled object using a predictive model.

For example, it is possible to use model predictive control r automatic operation control of vehicles.

Patent Literature 1 discloses a model predictive control system to change models automatically in accordance with external environment.

In this system, a model corresponding to the weather at a prediction time is selected from models prepared for each weather, the model selected is corrected based on the outside air temperature, and model predictive control is performed using the model after correction.

### CITATION LIST

### Patent Literature

Patent Literature 1: JP 2000-099107 A

### SUMMARY OF INVENTION

### Technical Problem

It is impossible for the system disclosed in Patent Literature 1 to handle an unexpected external environment.

For example, even when a sunny model, a cloudy model, a rainy model and a snowy model are prepared, it is impossible to select an appropriate model for a special weather such as a typhoon, and so on. Further, even if it is possible to select a model appropriate for the weather at the time of prediction, when the outside air temperature at the time of prediction is a temperature beyond a range of assumption, it is impossible to correct the model appropriately.

As a result, the precision of model predictive control is decreased.

The present invention is aimed at making it possible to maintain precision of model predictive control even under an unanticipated environment.

### Solution to Problem

There is provided according to one aspect of the present invention, a model predictive control device includes:

an operation quantity time-series generation unit to generate, based on a measurement state quantity output from a state sensor to measure a state of a controlled object, an operation quantity time series for an actuator in order to make the state of the controlled object change;

a predictive model unit to generate, by calculating a predictive model by using the measurement state quantity and the operation quantity time series as an input, a state quantity predictive time series being a state quantity time series of prediction of the controlled object;

a neural network unit to correct the state quantity predictive time series by performing an arithmetic operation of a neural network, by using, as an input, a measurement environment quantity output from an environment sensor to measure an operating environment of the controlled object, and the state quantity predictive time series;

a state quantity evaluation unit to generate, by calculating an evaluation function by using the state quantity predictive time series after correction as an input, an evaluation result for a. state quantity time series after the correction, and

an operation quantity determination unit to output to the actuator an operation quantity at a head of the operation quantity time series when the evaluation result fulfils an appropriate criterion.

### Advantageous Effects of Invention

According to the present invention, a state quantity predictive time series is corrected by performing arithmetic operation of a neural network by using, as an input, a state quantity predictive time series obtained by a predictive model, and a measurement environment quantity output from an environment sensor. Therefore, it is possible to correct the state quantity predictive time series even in an unanticipated environment. Therefore, it is possible to maintain precision of model predictive control even under an unanticipated environment.

### BRIEF DESCRIPTION OF DRAWINGS

FIG. 1 is a configuration diagram of a model predictive control system 100 according to a first embodiment;

FIG. 2 is a configuration diagram of a model predictive control device 200 according to the first embodiment;

FIG. 3 is an explanatory diagram of model predictive control according to the first embodiment;

FIG. 4 is an explanatory diagram of model predictive control according to the first embodiment;

FIG. 5 is a flowchart of a model predictive control method according to the first embodiment;

FIG. 6 is a diagram illustrating a neural network 231 according to the first embodiment;

FIG. 7 is a configuration diagram of a model predictive control system 190 wherein the neural network 231 is not used;

FIG. 8 is a configuration diagram of the model predictive control system 190 used for automatic operation control of a vehicle;

FIG. 9 is a diagram illustrating automatic operation control of a vehicle by the model predictive control system 190;

FIG. 10 is an explanatory diagram of automatic operation control of a vehicle;

FIG. 11 is a configuration diagram of a model predictive control system 100 according to a second embodiment;

FIG. 12 is a configuration diagram of a model predictive control device 200 according to the second embodiment;

FIG. 13 is a configuration diagram of a history unit 280 according to the second embodiment;

FIG. 14 is a schematic diagram of a learning method according to the second embodiment;

FIG. 15 is a flowchart of a learning method according to the second embodiment;

FIG. 16 is a configuration diagram of a model predictive control system 300 according to a third embodiment;

FIG. 17 is a configuration diagram of a model predictive control device 400 according to the third embodiment;

FIG. 18 is a flowchart of a model predictive control method according to the third embodiment;

FIG. 19 is a diagram illustrating a neural network 411 according to the third embodiment;

FIG. 20 is a configuration diagram of hardware of a model predictive control device 200 according to the embodiments; and

FIG. 21 is a configuration diagram of hardware of a model predictive control device 400 according to the embodiments.

### DESCRIPTION OF EMBODIMENTS

In embodiments and diagrams, same elements or corresponding elements are denoted by same reference numerals. Explanation for the elements with the same reference numerals as elements that have been explained will be omitted or simplified appropriately. Arrows in the diagrams mainly illustrate flows of data or flows of processing.

### First Embodiment

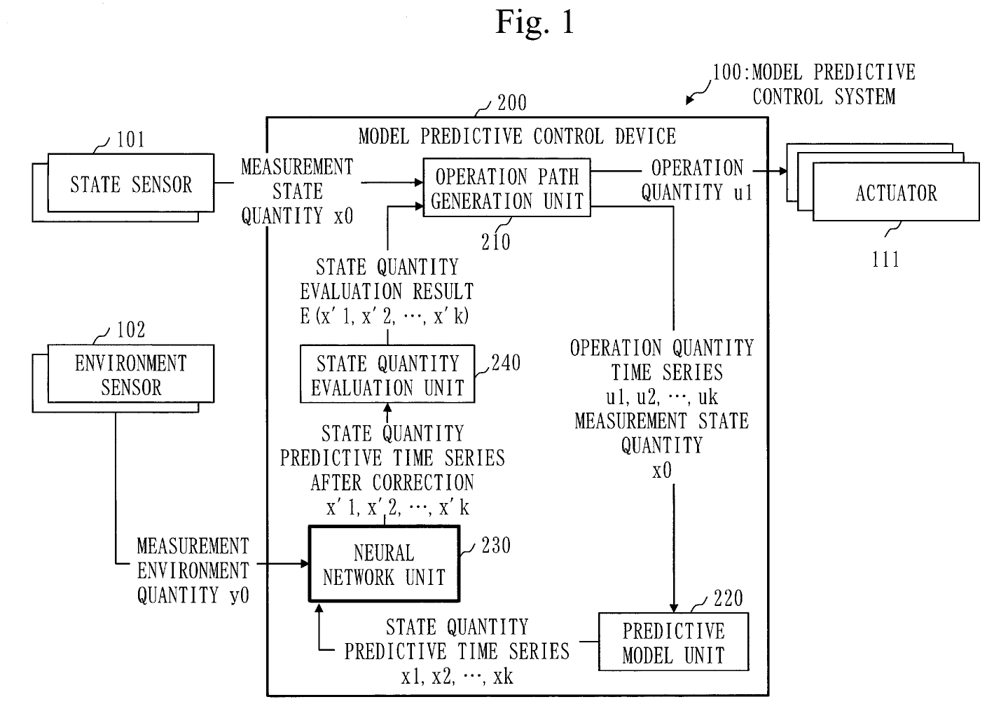

Explanation will be provided of a model predictive control system 100 using a neural network based on FIG. 1 through FIG. 10.

The model predictive control system 100 is a system for controlling a controlled object by model predictive control (MPC). The model predictive control will be discussed later.

For example, the model predictive control system 100 can be used for realizing automatic operation of a vehicle.

***Description of Configuration***

Based on FIG. 1, the configuration of the model predictive control system 100 will be described.

The model predictive control system 100 includes a state sensor group, an environment sensor group, an actuator group and a model predictive control device 200.

The state sensor group is one or more state sensors 101.

The state sensors 101 are sensors to measure states of a controlled object.

For example, the controlled object is a vehicle, and a state sensor 101 is a speed sensor or a position sensor. The speed sensor measures a speed of the vehicle. The position sensor measures a position of the vehicle.

The environment sensor group is one or more environment sensors 102.

The environment sensors 102 are sensors to measure an operating environment of a controlled object.

For example, the controlled object is a vehicle, and an environment sensor 102 is a car weight sensor or an attitude sensor. The car weight sensor measures a weight of the vehicle (including weights of an occupant and luggage). The attitude sensor measures an attitude (inclination) of the vehicle. The attitude of the vehicle corresponds to an inclination of a road surface.

The actuator group is one or more actuators 111.

The actuators 111 change states of a controlled object.

For example, the controlled object is a vehicle, and an actuator 111 is a steering, a motor or a brake.

The model predictive control device 200 is a device to control a controlled object by model predictive control (MPC). Model predictive control will be discussed later.

For example, the model predictive control device 200 performs automatic operation control over a vehicle.

The model predictive control device 200 is characterized by including a neural network unit 230.

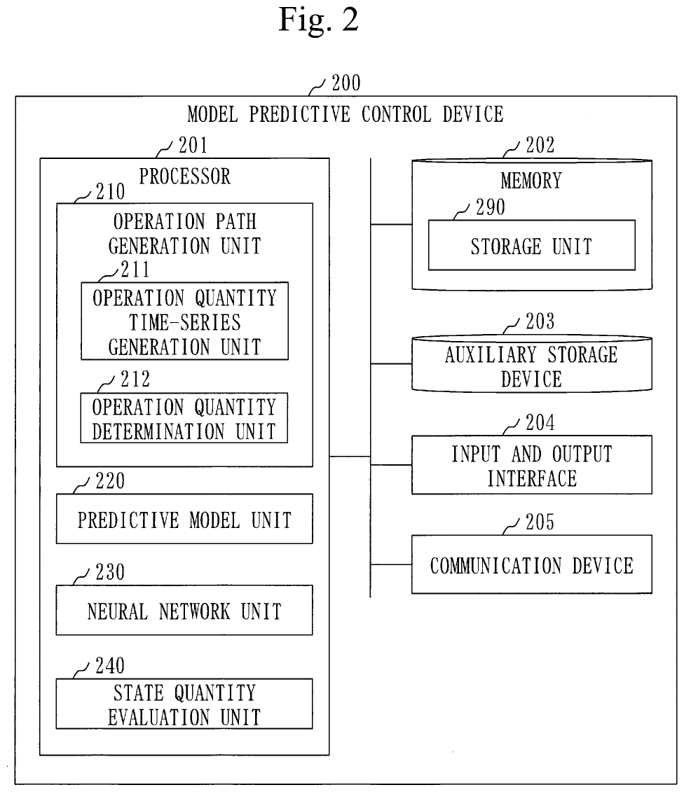

Based on FIG. 2, a configuration of the model predictive control device 200 will be described.

The model predictive control device 200 is a computer including hardware components such as a processor 201, a memory 202, an auxiliary storage device 203, an input and output interface 204 and a communication device 205. These hardware components are connected to one another via signal lines.

The processor 201 is an IC that performs arithmetic processing, which controls other hardware components. For example, the processor 201 is a CPU, a DSP or a GPU.

IC is an abbreviation for “integrated circuit.”

CPU is an abbreviation for “central processing unit.”

DSP is an abbreviation for “digital signal processor.”

GPU is an abbreviation for “graphics processing unit.”

The memory 202 is a volatile storage device. The memory 202 is also called a main storage device or a main memory. For example, the memory 202 is a RAM. Data stored in the memory 202 is stored in the auxiliary storage device 203 as needed.

RAM is an abbreviation for “random access memory.”

The auxiliary storage device 203 is a non-volatile storage device. For example, the auxiliary storage device 203 is a ROM, an FIDD or a flash memory. Data stored in the auxiliary storage device 203 is loaded into the memory 202 as needed.

ROM is an abbreviation for “read only memory.”

HDD is an abbreviation for “hard disk drive.”

The input and output interface 204 is a port whereto an input device and an output device are connected. For example, the state sensor group, the environment sensor group and the actuator group are connected to the input and output interface 204. USB is an abbreviation for “universal serial bus.”

The communication device 205 is a receiver and a transmitter. For example, the communication device 205 is a communication chip or an NIC.

NIC is an abbreviation for “network interface card.”

The model predictive control device 200 includes elements such as an operation path generation unit 210, a predictive model unit 220, the neural network unit 230 and a state quantity evaluation unit 240. These elements are realized by software.

The operation path generation unit 210 includes an operation quantity time-series generation unit 211 and an operation quantity determination unit 212.

The auxiliary storage device 203 stores a model predictive control program to make a computer function as the operation path generation unit 210, the predictive model unit 220, the neural network unit 230 and the state quantity evaluation unit 240. The model predictive control program is loaded into the memory 202, and executed by the processor 201.

The auxiliary storage device 203 further stores an OS. At least a part of the OS is loaded into the memory 202, and executed by the processor 201.

The processor 201 executes the model predictive control program while executing the OS.

OS is an abbreviation for “operating system.”

The input and output data of the model predictive control program is stored in a storage unit 290.

The memory 202 functions as the storage unit 290. However, storage devices such as the auxiliary storage device 203, an register inside the processor 201 and a cache memory inside the processor 201, etc. may function as the storage unit 290 instead of the memory 202, or along with the memory 202.

The model predictive control device 200 may include a plurality of processors replacing the processor 201. The plurality of processors share roles of the processor 201.

The model predictive control program may be recorded on (stored in) non-volatile storage medium such as an optical disk or flash memory, etc. in a computer-readable manner.

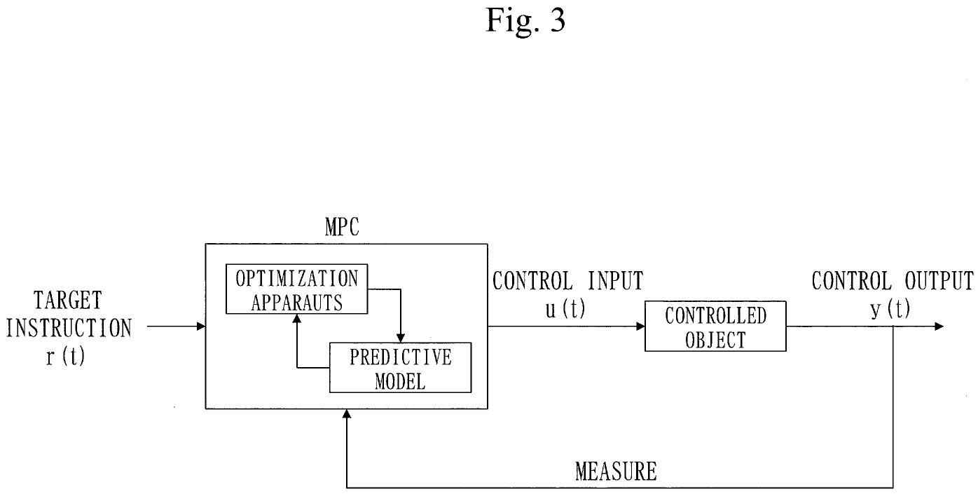

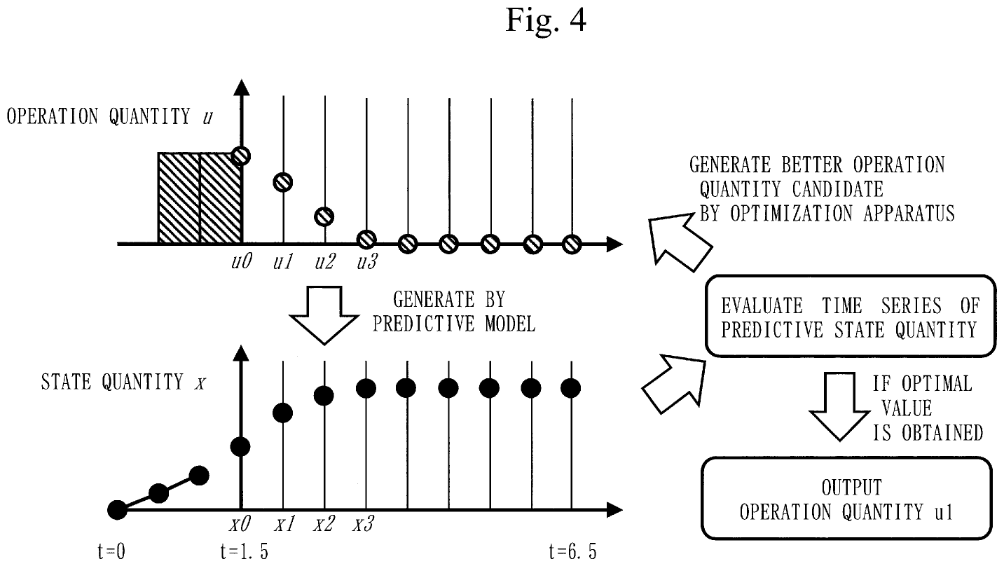

Model predictive control (MPC) will be discussed based on FIG. 3 and FIG. 4. Model predictive control is a conventional technique.

First, model predictive control will be discussed based on FIG. 3.

Model predictive control is one control method to calculate an optimal control input using predictive estimation of a controlled object.

In model predictive control, a predictive model and an optimization apparatus are used. The predictive model is a. model to mimic a controlled object. The optimization apparatus evaluates operations of the predictive model, and calculates an optimal control input.

A set of the operation path generation unit 210 and the state quantity evaluation unit 240 correspond to the optimization apparatus.

Next, model predictive control will be discussed based on FIG. 4. An operation quantity u corresponds to a control input u(t) in FIG. 3.

In model predictive control, a time series xi of a predictive state quantity is generated based on a time series ui being a candidate of the operation quantity, and quality of the predictive state quantity is judged by an evaluation function. This process is repeated until a predictive state quantity with high evaluation is obtained. Then, an operation quantity u1 corresponding to a predictive state quantity with a high evaluation is output.

***Description of Operation***

The operation of the model predictive control system 100 corresponds to a model predictive control method. Further, a procedure of the model predictive control method by the model predictive control device 200 corresponds to the procedure of the model predictive control program.

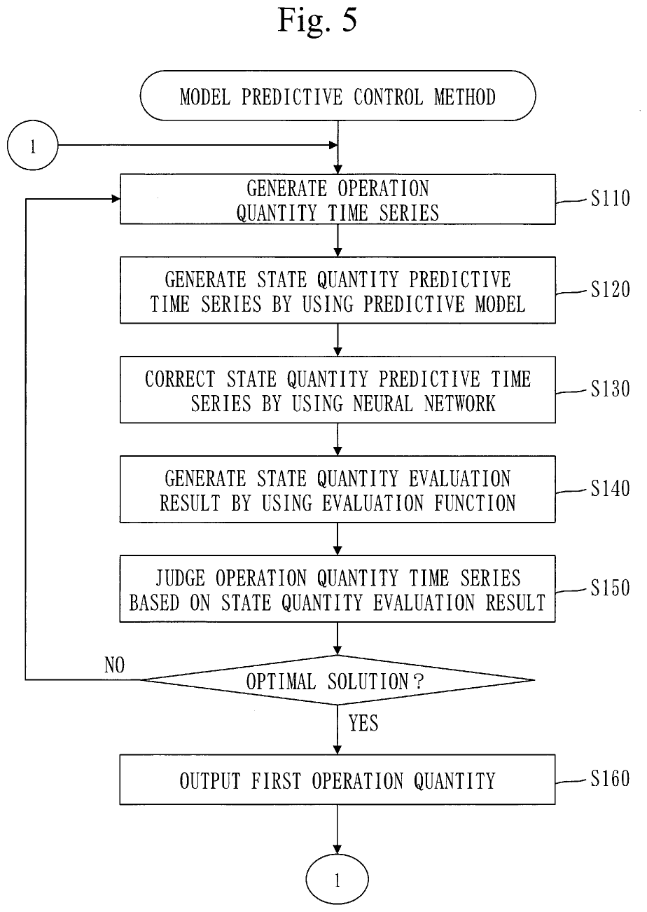

The model predictive control method will be discussed based on FIG. 5.

To make explanation simple, explanation will be provided by taking the state sensor group as one state sensor 101, the environment sensor group as one environment sensor 102, and the actuator group as one actuator 111.

The state sensor 101 periodically measures a state of a controlled object, and outputs a measurement state quantity. The measurement state quantity is a state quantity obtained by measuring the state of the controlled object, The state quantity represents the state of the controlled object.

The environment sensor 102 periodically measures an operating environment of the controlled object, and outputs the measurement environment quantity. The measurement environment quantity is an environment quantity obtained by measuring the operating environment of the controlled object, The environment quantity represents the operating environment of the controlled object.

The step S110 through the step S160 are performed repeatedly.

In the step S110, the operation quantity time-series generation unit 211 accepts a measurement state quantity output from the state sensor 101.

The operation quantity time-series generation unit 211 generates an operation quantity time series based on the measurement state quantity accepted.

Then, the operation quantity time-series generation unit 211 outputs the measurement state quantity and the operation quantity time series.

The operation quantity time series is a plurality of operation quantities arranged in time order, which corresponds to a time series ui being a candidate of an operation quantity in conventional model predictive control (refer to FIG. 4).

A method to generate the operation quantity time series is the same as the method to generate the time series ui being the candidate of the operation quantity in the conventional model predictive control.

In the step S120, the predictive model unit 220 accepts the measurement state quantity and the operation quantity time series output from the operation quantity time-series generation unit 211.

The predictive model unit 220 calculates a predictive model using as an input the measurement state quantity and the operation quantity time series. In this manner, a state quantity predictive time series is generated.

Then, the predictive model unit 220 outputs the state quantity predictive time series.

The state quantity predictive time series is a state quantity time series predicted by the predictive model.

The state quantity time series is a plurality of state quantities arranged in time order, which corresponds to a time series xi of a predictive state quantity in the conventional model predictive control (refer to FIG. 4).

A method to generate the state quantity predictive time series is the same as the method to generate the time series xi of the predictive state quantity in the conventional model predictive control.

In the step S130, the neural network unit 230 accepts a measurement environment quantity output from the environment sensor 102, and a state quantity predictive time series output from the predictive model unit 220.

The neural network unit 230 performs arithmetic operation of a neural network 231 by using as an input the measurement environment quantity and the state quantity predictive time series. In this manner, the state quantity predictive time series is corrected.

Then, the neural network unit 230 outputs the state quantity predictive time series after correction.

The neural network 231 will be discussed later.

In the step S140, the state quantity evaluation unit 240 accepts the state quantity predictive time series after correction output from the neural network unit 230.

The neural network unit 230 calculates an evaluation function by using as an input the state quantity predictive time series after correction. In this manner, a state quantity evaluation result is generated.

Then, the state quantity evaluation unit 240 outputs the state quantity evaluation result.

The state quantity evaluation result is an evaluation result for the state quantity predictive time series after correction, which corresponds to an evaluation result for the time series xi of the predictive state quantity in the conventional model predictive control (refer to FIG. 4).

A method to generate the state quantity evaluation result is the same as the method to generate the evaluation result for the time series xi of the predictive state quantity in the conventional model predictive control.

In the step S150, the operation quantity determination unit 212 accepts the state quantity evaluation result output from the state quantity evaluation unit 240.

Then, the operation quantity determination unit 212 judges whether the state quantity evaluation result fulfils an appropriate criterion. The appropriate criterion is a criterion determined beforehand. The judgment method is the same as the method in the conventional model predictive control.

When the state quantity evaluation result fulfils the appropriate criterion, the operation quantity time series generated in the step S110 is an optimal operation quantity time series, i.e., an optimal solution.

When the operation quantity time series generated in the step S110 is the optimal solution, the processing proceeds to the step S160.

When the operation quantity time series generated in the step S110 is not the optimal solution, the processing proceeds to the step S110. Then, another operation quantity time series is generated in the step S110.

In the step S160, the operation quantity determination unit 212 outputs to the actuator 111 an operation quantity of at the head of the operation quantity time series (optimal solution) generated in the step S110. The operation quantity at the head is called “first operation quantity.”

The actuator 111 accepts the first operation quantity output from the operation quantity determination unit 212. Then, the actuator 111 operates in accordance with the first operation quantity accepted. As a result, a state of the controlled object changes.

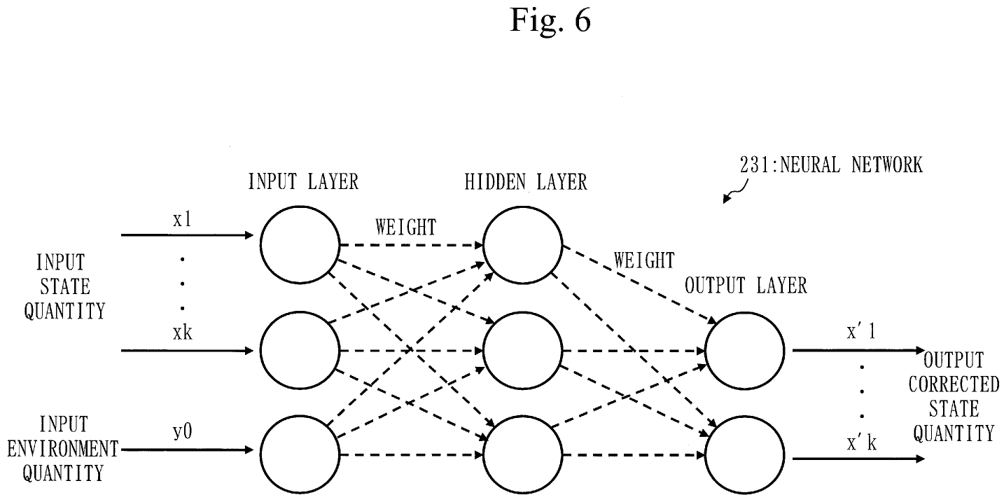

The neural network 231 swill be discussed based on FIG. 6.

The neural network 231 is a neural network for the model predictive control system 100.

A configuration of a neural network will be discussed.

The neural network has an input layer, a hidden layer and an output layer.

Each layer includes one or more nodes. A circle represents a node.

Nodes between layers are connected by an edge. A dotted line represents an edge.

A weight is set to each edge.

A value of a node in a latter layer is determined based on a value of a node in a former layer and a weight set to an edge.

In the neural network 231, a state quantity predictive time series (x1, . . . , xk) and a measurement environment quantity (y0) are input to the input layer. Then, the state quantity predictive time series (x′1, . . . , x′k) after correction is an output from the output layer.

***Effect of First Embodiment***

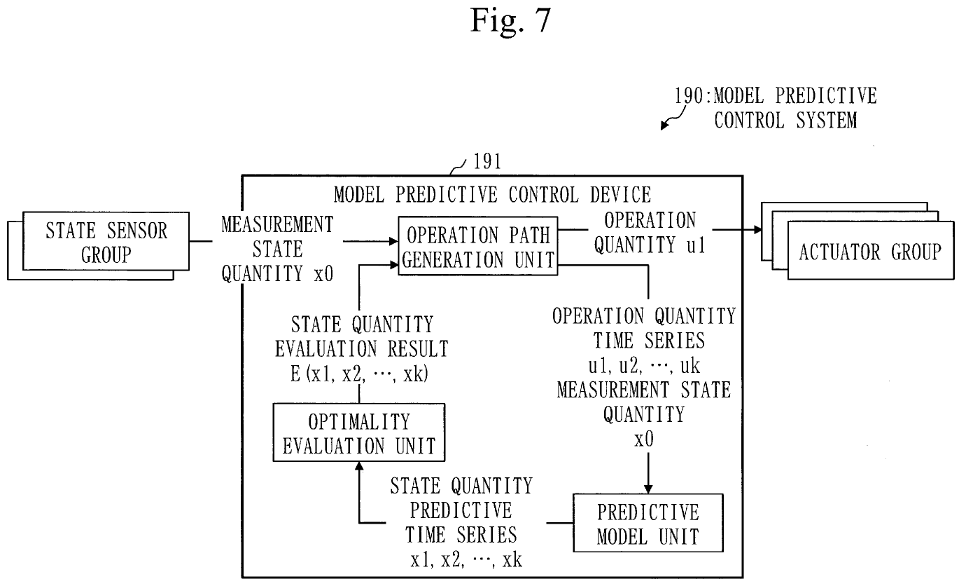

A task of the model predictive control device 191 wherein the neural network 231 is not used will be discussed based on FIG. 7 through FIG. 10.

FIG. 7 illustrates a configuration of the model predictive control system 190 wherein the neural network 231 is not used.

The model predictive control system 190 does not include an environment sensor group.

Further, the model predictive control device 191 does not include a function corresponding to the neural network unit 230.

Therefore, it is impossible for the model predictive control device 191 to correct a state quantity predictive time series based on a measurement environment quantity.

However, the state sensor group and the actuator group are exposed to an external environment. Therefore, a state quantity measured by the state sensor group and a state quantity changed by the actuator group do not always coincide with the state quantity predictive time series,

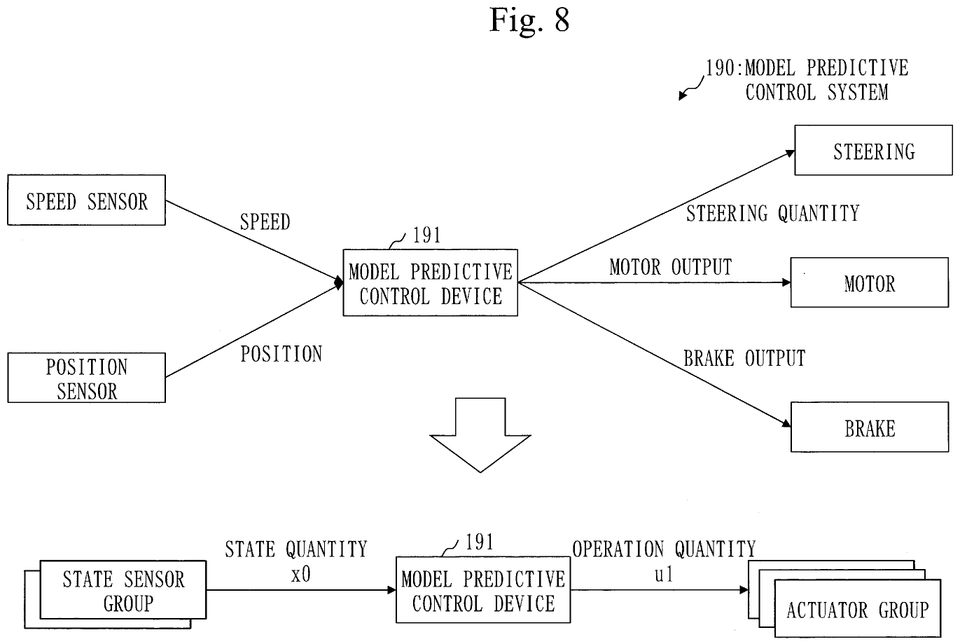

FIG. 8 illustrates a configuration of the model predictive control system 190 used in automatic operation control of a vehicle.

The model predictive control system 190 is equipped with state sensors such as a vehicle speed sensor and a position sensor. Further, the model predictive control system 190 is equipped with actuators such as a steering, a motor and a brake.

The model predictive control device 191 determines a steering quantity, a motor output and a brake output based on the speed of the vehicle and the position of the vehicle.

When the model predictive control system 190 is generalized, the model predictive control system 190 is considered to be a system to output an operation quantity based on a state quantity.

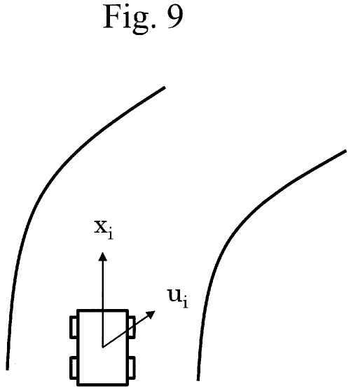

FIG. 9 illustrates a condition of automatic operation control of a vehicle by the model predictive control system 190.

The model predictive control device 191 outputs an operation quantity uᵢ to make a state quantity xᵢ (vehicle speed, vehicle position) change. In this manner, a travel route of the vehicle is controlled.

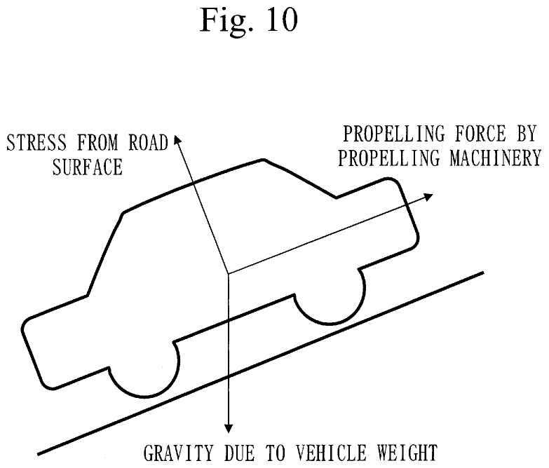

Automatic operation control of a vehicle will be discussed based on FIG. 10,

In a vehicle, gravity due to a vehicle weight, stress from a road surface and a propelling force by a propelling machinery, etc. are caused.

An amount of acceleration Δᵥ of a vehicle can be represented by a formula (1).

“M” represents a vehicle weight. “θ” represents an inclination angle of a vehicle. “F” represents an operation quantity of a propelling machinery. “g” represents gravitational acceleration.

“X_{gain}” represents a gain correction quantity. “Xₛₑₙₛ” represents a measurement state quantity, “X_{ofs}” represents an offset correction quantity.

$$\begin{matrix}[ Expression 1 ] & \\ {Δ}_{v} = {Δ}_{t} a = {Δ}_{t} ( \frac{F}{M} - g sin ( θ ) ) \\ θ = {Θ}_{gain} {θ}_{sens} + {Θ}_{ofs} \\ M = {M}_{gain} {M}_{sens} + {M}_{ofs} & ( 1 )\end{matrix}$$

However, it is necessary to perform correction, after calibrating each state sensor, in consideration of other errors. Further, it is necessary to consider further when a measurement state quantity has a non-linear characteristic.

Furthermore, the gain correction quantity X_{gain} and the offset correction quantity X_{ofs} rely on the operating environment.

Therefore, if the operation environment is not considered, the accuracy of automatic operation control over a vehicle may be degraded.

Meanwhile, the model predictive control device 200 in the first embodiment realizes control in consideration of an operating environment by using the neural network 231. As a result, it is possible to perform several types of control with high level of accuracy.

For example, even when correct calibration is not performed for state sensors of a vehicle, it is possible to realize automatic operation control with a high level of accuracy.

### Second Embodiment

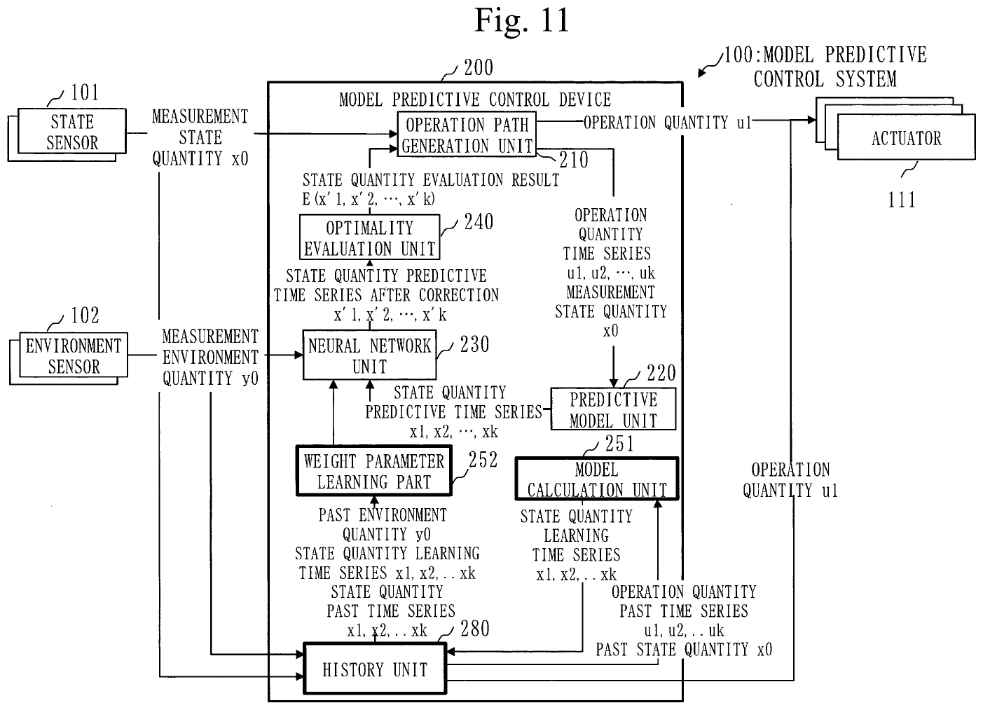

With respect to an embodiment wherein a weight parameter of the neural network 231 is learned, parts which are different from the first embodiment will be mainly discussed based on FIG. 11 through FIG. 15.

***Description of Configuration***

A configuration of the model predictive control system 100 will be discussed based on FIG. 11.

The configuration of the model predictive control system 100 is the same as the configuration in the first embodiment except the configuration of the model predictive control device 200 (refer to FIG. 1).

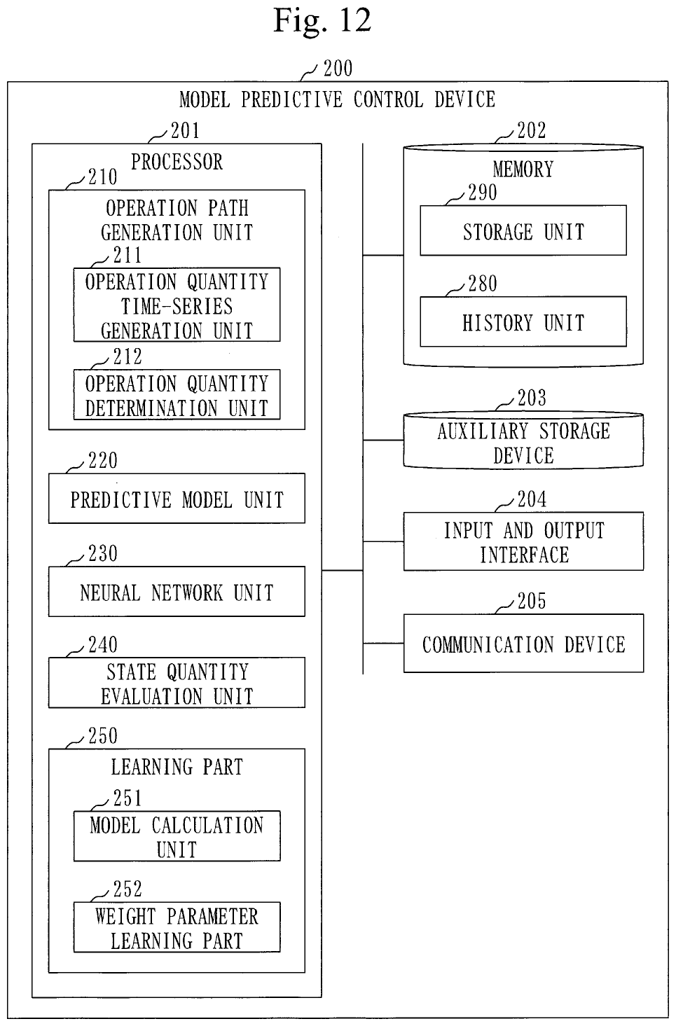

The configuration of the model predictive control device 200 will be discussed based on FIG. 12.

The model predictive control device 200 further includes a learning part 250. The learning part 250 includes a model calculation unit 251 and a weight parameter learning part 252. The learning part 250 is realized by software.

The model predictive control program further makes a computer function as the learning part 250.

The model predictive control device 200 further includes a history unit 280. The history unit 280 is realized by a storage device such as a memory 202, etc.

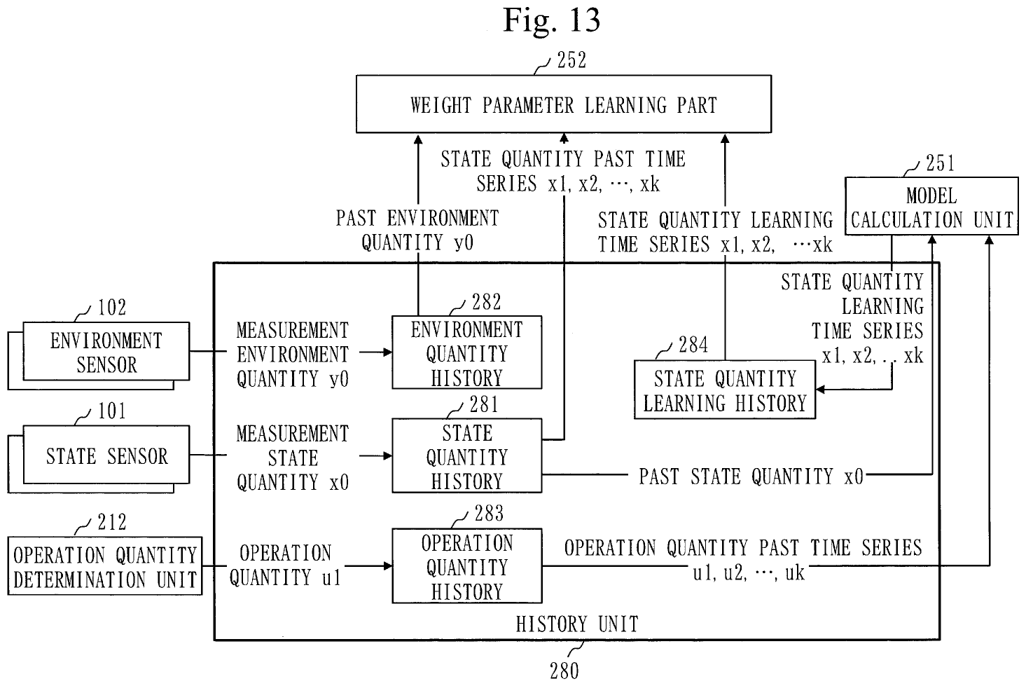

A configuration of the history unit 280 will be discussed based on FIG. 13.

The history unit 280 stores data such as state quantity history 281, environment quantity history 282, operation quantity history 283 and state quantity learning history 284.

The state quantity history 281 is history of a measurement state quantity, that is, a set of past measurement state quantities. The past measurement state quantity is called “past state quantity.” A time series of the past state quantity is called “state quantity past time series. ”

The environment quantity history 282 is history of a measurement environment quantity, that is, a set pf past measurement environment quantities. The past measurement environment quantity is called “past environment quantity.”

The operation quantity history 283 is history of operation quantity, that is, a set of past operation quantities. The past operation quantity is called “past operation quantity.” A time series of the past operation quantity is called “operation quantity past time series.”

The state quantity learning history 284 is history of a state quantity learning time series, that is, a set of past state quantity learning time series.

The state quantity teaming time series is a state quantity learning time series generated for learning of a weight parameter used in the neural network 231.

***Description of Operation***

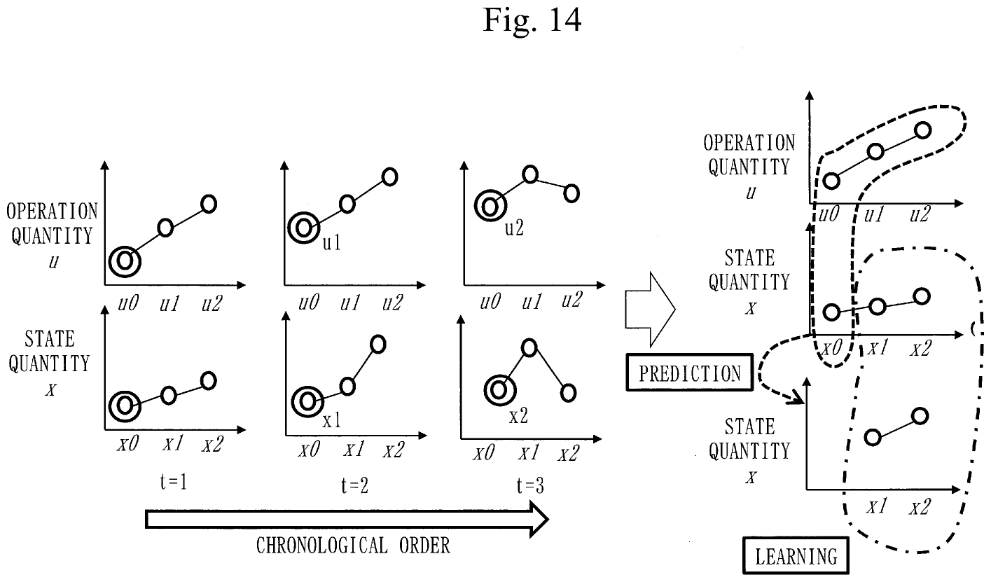

A summary of a learning method by the learning part 250 will be discussed based on FIG. 14.

“Prediction” means processing to generate a state quantity learning time series.

The state quantity learning time series corresponds to a state quantity predictive time series. That is, the state quantity learning time series is generated by calculating a predictive model the same as the predictive model used for generation of the state quantity predictive time series.

In “prediction,” an operation quantity past time series and a past state quantity are used.

The operation quantity past time series is a time series of the past operation quantity.

As an operation quantity u0 of the operation quantity past time series, an operation quantity u0 at a first time (t=1) is used.

As an operation quantity ul of the operation quantity past time series, an operation quantity u0 at a second time (t=2) is used.

As an operation quantity u2 of the operation quantity past time series, an operation quantity u0 of a third time (t=3) is used.

As a past state quantity, a state quantity x0 at the first time (t=1) is used.

“Learning” means processing to learn a weight parameter used in the neural network 231.

In “learning,” a state quantity learning time series and a state quantity past time series are used.

As a state quantity x1 of the state quantity past time series, the state quantity x0 at the second time (t=2) is used.

As a state quantity x2 of the state quantity past time series, the state quantity x0 at the third time (t=3) is used.

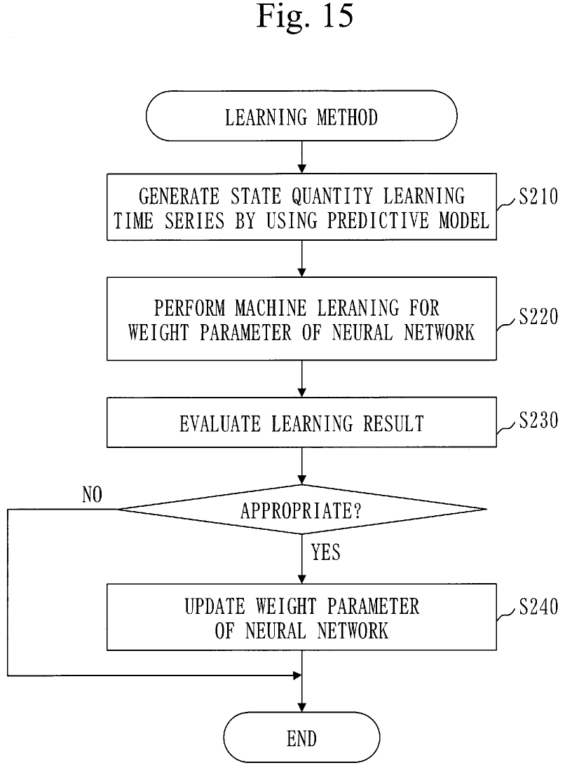

A learning method by the learning part 250 will be discussed based on FIG. 15.

The learning method is performed repeatedly. For example, the learning method is performed periodically, or every time an operation quantity is output to the actuator 111.

In the learning method, the history unit 280 operates in the following manner.

Every time a measurement state quantity is output from the state sensor 101, the history unit 280 stores the measurement state quantity output.

Every time a measurement environment quantity is output from the environment sensor 102, the history unit 280 stores the measurement environment quantity output.

Every time an operation quantity is output to the actuator 111 from the operation quantity determination unit 212, the history unit 280 stores the operation quantity output.

In a step S210, the model calculation unit 251 acquires a past state quantity and an operation quantity past time series from the history unit 280.

Then, the model calculation unit 251 calculates a predictive model by using as an input the past state quantity and the operation quantity past time series. The predictive model calculated by the model calculation unit 251 is the same as the predictive model calculated by the predictive model unit 220.

In this manner, a state quantity time series corresponding to the state quantity predictive time series is generated. The state quantity time series generated is called “state quantity learning time series.”

The model calculation unit 251 stores the state quantity learning time series in the history unit 280.

In a step S220, the weight parameter learning part 252 acquires the past environment quantity, the state quantity past time series and the state quantity learning time series from the history unit 280.

Then, the weight parameter learning part 252 performs machine learning for a weight parameter of the neural network 231 using the state quantity learning time series, the past environment quantity and the state quantity past time series.

Specifically, the weight parameter learning part 252 calculates a weight parameter of the neural network 231 so that a state quantity learning time series after correction obtained by performing the neural network 231 by using as an input the state quantity learning time series and the past environment quantity coincides with the state quantity past time series.

In a step S230, the weight parameter learning part 252 evaluates the weight parameter (learning result) obtained by machine learning.

The evaluation of the learning result is performed in the following manner.

In the step S210, the model calculation unit 251 generates a plurality of state quantity learning time series in a learning target period, by using a plurality of past state quantities in the learning target period and a plurality of operation quantity past time series in the learning target period.

In the step S220, the weight parameter learning part 252 performs machine learning for a weight parameter of the neural network 231, by using a plurality of state quantity learning time series in a first time period, a plurality of past environment quantities in the first time period, and a plurality of state quantity past time series in the first time period. The first time period is a part of the learning target period. For example, the first time period is a former half of the learning target period.

In the step S230, the weight parameter learning part 252 temporarily sets the weight parameter acquired by machine learning in the neural network 231. Next, the weight parameter learning part 252 performs arithmetic operation of the neural network 231 by using as an input a plurality of state quantity learning time series in a second time period and a plurality of past environment quantities in the second time period. In this manner, a plurality of state quantity correction time series in the second time series are obtained. The second time period is a part of the learning target period. For example, the second time period is a latter half of the learning target period. The state quantity correction time series is a state quantity learning time series after correction. Then, the weight parameter learning part 252 evaluates a learning result based on an error quantity between the plurality of state quantity correction time series in the second time period and the plurality of state quantity past time series in the second time period. The evaluation for the learning result is performed by using a general index in deep learning.

When it is acquired an evaluation result that an appropriate learning result is obtained, the processing proceeds to a step S240.

When it is acquired an evaluation result that an appropriate learning result is not obtained, the weight parameter obtained in the step S220 is discarded, and the processing of the learning method ends. In this case, the weight parameter of the neural network 231 is not updated.

In the step S240, the weight parameter learning part 252 sets the weight parameter obtained in the step S220 in the neural network 231. In this manner, the weight parameter of the neural network 231 is updated.

After the step S240, the neural network unit 230 performs correction of the state quantity predictive time series by performing arithmetic operation of the neural network 231 after update.

***Effect of Second Embodiment***

It is possible to learn a weight parameter of the neural network 231. Therefore, accuracy of correction by the neural network 231 is improved. As a result, the level of accuracy of model predictive control is improved.

### Third Embodiment

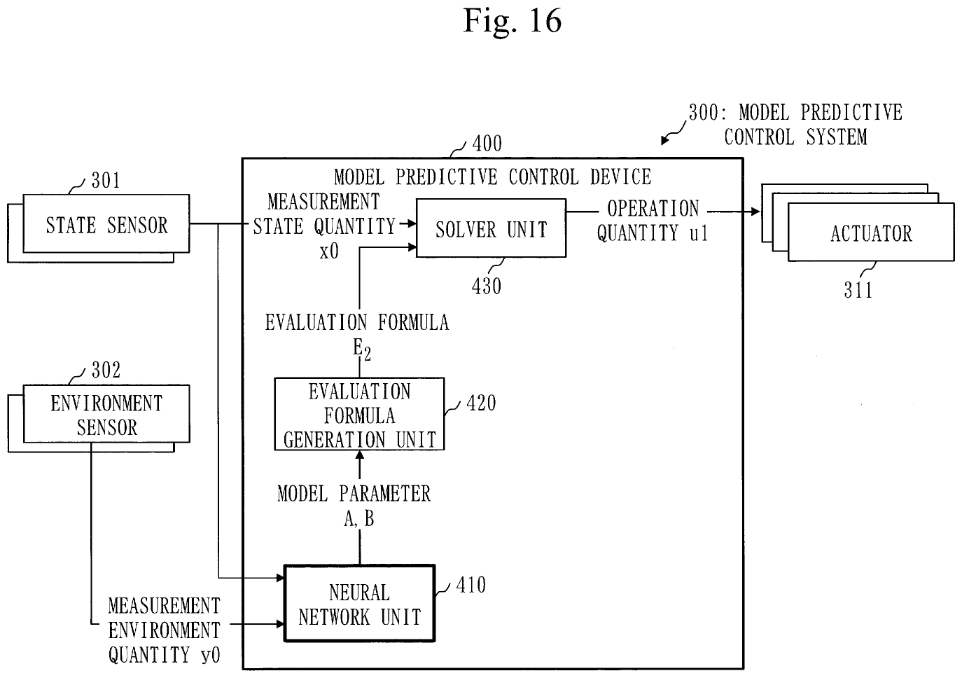

A model predictive control system 300 to calculate an operation quantity by using quadratic programming will be discussed based on FIG. 16 through FIG. 19.

The model predictive control system 300 is a system to control a controlled object by model predictive control (MPC). The model predictive control is just as described in the first embodiment.

For example, the model predictive control system 300 can be used for realizing automatic operation of a vehicle.

***Description of Configuration***

A configuration of the model predictive control system 300 will be discussed based on FIG. 16.

The model predictive control system 300 is equipped with a state sensor group, an environment sensor group, an actuator group and a model predictive control device 400.

The state sensor group is one or more state sensors 301.

The state sensors 301 are sensors to measure states of a controlled object. For example, the controlled object is a vehicle, and a state sensor 301 is a speed sensor or a position sensor. The speed sensor measures speed of a vehicle. The position sensor measures a position of a vehicle.

The environment sensor group is one or more environment sensors 302.

The environment sensors 302 are sensors to measure an operating environment of a controlled object.

For example, the controlled object is a vehicle, and an environment sensor 302 is a vehicle weight sensor or an attitude sensor. The vehicle weight sensor measures a weight of a vehicle (including weights of an occupant and a luggage). The attitude sensor measures an attitude (inclination) of a vehicle. The vehicle attitude corresponds to an inclination of a road surface.

The actuator group is one or more actuators 311.

The actuators 311 change states of a controlled object.

For example, the controlled object is a vehicle, and an actuator 311 is a steering, a motor or a brake.

The model predictive control device 400 is a device to control a controlled object by model predictive control (MPC).

For example, the model predictive control device 400 performs automatic operation control over a vehicle.

The model predictive control device 400 is characterized by including a neural network unit 410.

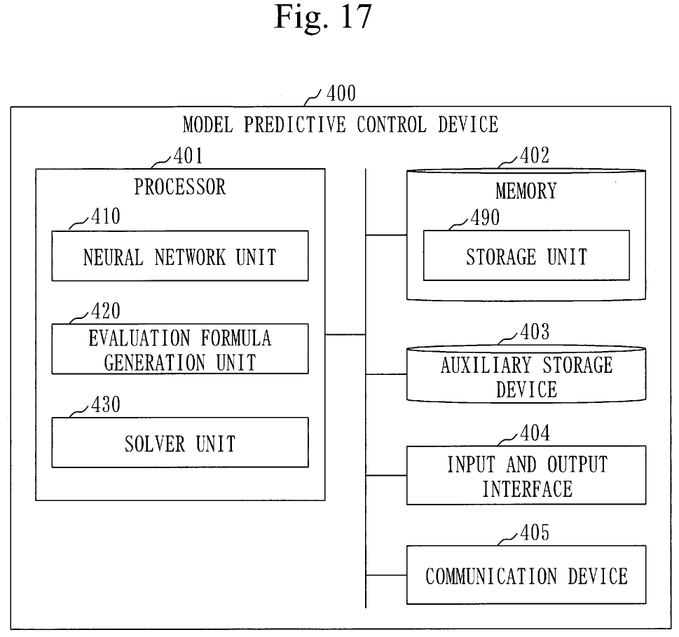

A configuration of the model predictive control device 400 will be discussed based on FIG. 17.

The model predictive control device 400 is a computer equipped with hardware components such as a processor 401. a memory 402, an auxiliary storage device 403, an input and output interface 404 and a communication device 405. These hardware components are connected to one another via signal lines.

The processor 401 is an IC that performs arithmetic processing, and controls other hardware components. For example, the processor 401 is a CPU, a DSP or a GPU.

The memory 402 is a volatile storage device. The memory 402 is also called a main storage device or a main memory. For example, the memory 402 is a RAM. The data stored in the memory 402 is stored in the auxiliary storage device 403 as needed.

The auxiliary storage device 403 is a non-volatile storage device. For example, the auxiliary storage device 403 is a ROM, an HDD or a flash memory. The data stored in the auxiliary storage device 403 is loaded into the memory 402 as needed.

The input and output interface 404 is a port whereto an input device and an output device are connected. For example, the state sensor group, the environment sensor group and the actuator group are connected to the input and output interface 404.

The communication device 405 is a receiver and a transmitter. For example, the communication device 405 is a communication chip or an NIC.

The model predictive control device 400 includes elements such as the neural network unit 410, an evaluation formula generation unit 420 and a solver unit 430. These elements are realized by software.

The auxiliary storage device 403 stores a model predictive control program to make a computer function as the neural network unit 410, the evaluation formula generation unit 420 and the solver unit 430. The model predictive control program is loaded into the memory 402, and executed by the processor 401.

The auxiliary storage device 403 further stores an OS, At least a part of the OS is loaded into the memory 402, and executed by the processor 401.

The processor 401 executes the model predictive control program while executing the OS.

The input and output data of the model predictive control program is stored in a storage unit 490.

The memory 402 functions as the storage unit 490. However, storage devices such as the auxiliary storage device 403, a register inside the processor 401 and a cache memory inside the processor 401, etc. may function as the storage unit 490, instead of the memory 402, or along with the memory 402.

The model predictive control device 400 may include a plurality of processors replacing the processor 401. The plurality of processors share roles of the processor 401.

The model predictive control program can be recorded on (stored in) a non-volatile recording medium such as an optical disk or a flash memory, etc. in a computer-readable manner.

***Description of Operation***

The operation of the model predictive control system 100 corresponds to a model predictive control method. Further, a procedure of the model predictive control method by the model predictive control device 200 corresponds to a procedure of a model predictive control program.

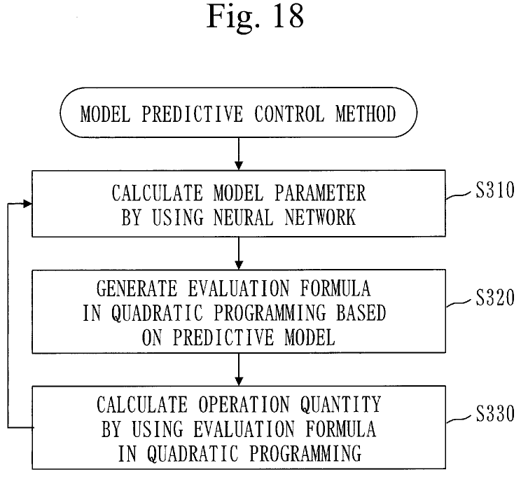

The model predictive control method will be discussed based on FIG. 18.

To make explanation simple, explanation will be provided by taking the state sensor group as one state sensor 101, the environment sensor group as one environment sensor 102, and the actuator group as one actuator 111.

The state sensor 301 periodically measures a state of a controlled object, and outputs a measurement state quantity. The measurement state quantity is a state quantity obtained by measuring the state of the controlled object. The state quantity represents the state of the controlled object.

The environment sensor 302 periodically measures an operating environment of a controlled object, and outputs a measurement environment quantity. The measurement environment quantity is an environment quantity obtained by measuring an operating environment of the controlled object. The environment quantity represents the operating environment of the controlled object.

A step S310 through a step S330 are performed repeatedly.

In the step S310, the neural network unit 410 accepts a measurement state quantity output from the state sensor 301.

Further, the neural network unit 410 accepts a measurement environment quantity output from the environment sensor 302.

The neural network unit 410 calculates a neural network 411 by using as an input the measurement state quantity and the measurement environment quantity. In this manner, a model parameter to be set in a predictive model for predicting change in the state of the controlled object is calculated.

Then, the neural network unit 410 outputs the model parameter calculated.

It is possible to express the predictive model by a formula (2).

Xₖ₊₁=Axₖ+Buₖ (2)

“Xn” is an n-th state quantity of a controlled object.

“uₙ” is an n-th operation quantity for the actuator 311.

“A” is a matrix being one model parameter.

“B” is a vector being one model parameter.

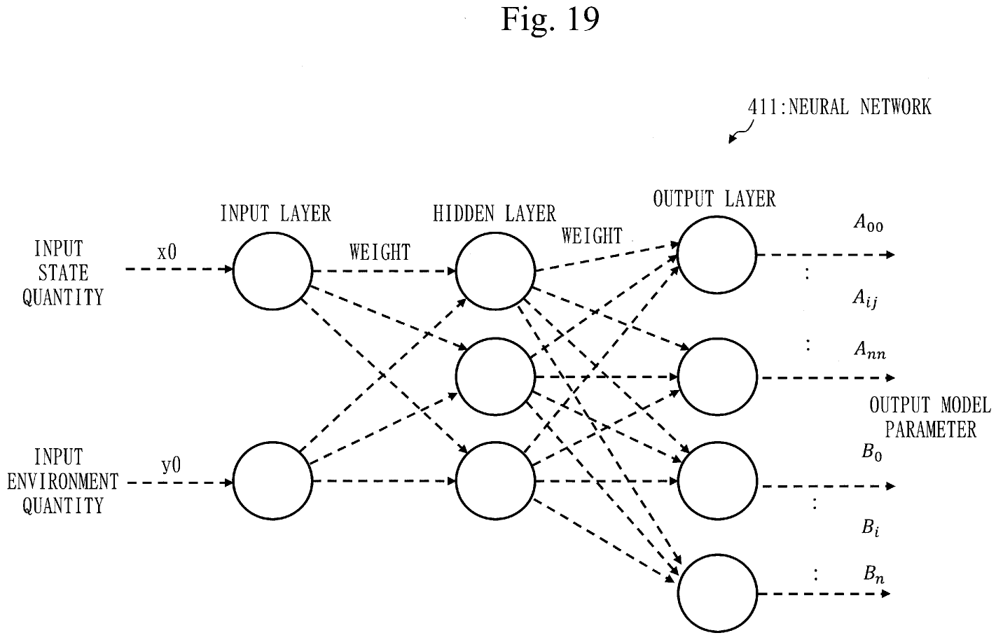

The neural network 411 will be discussed based on FIG. 19.

The neural network 411 is a neural network for the model predictive control system 300.

A configuration of the neural network is just as described in the first embodiment.

In the neural network 411, a measurement state quantity x0 and a measurement environment quantity y0 are inputs to an input layer. Meanwhile, a model parameter (A, B) is an output from an output layer.

(A₀₀, . . . , Aᵢⱼ, . . . , Aₙₙ) constitutes a matrix A.

(B₀, . . . , Bᵢ, . . . , Bₙ) constitutes a matrix B.

Returning to FIG. 18, description s continued from the step S320.

In the step S320, the evaluation formula generation unit 420 generates an evaluation formula in quadratic programming based on a predictive model wherein the model parameter calculated is set. The evaluation formula generated is a formula to evaluate an operation quantity time series for the actuator 311.

Then, the evaluation formula generation unit 420 outputs the evaluation formula in quadratic program

It will be described an evaluation formula in quadratic programming.

It is possible to represent an. evaluation function for the predictive model by a formula (3).

“E₁” is an evaluation value obtained by an evaluation function.

“X_{Tk}” is a desired value of a state quantity.

“Xₖ” is a state quantity calculated by performing an operation of a predictive model wherein the matrix A and the vector B are set.

$$\begin{matrix}[ Expression 2 ] & \\ {E}_{1} = {\sum }_{k = 1}^{n} \{ {( {x}_{k} - {x}_{{T}_{k}} )}^{2} + {u}_{k}^{2} \} & ( 3 )\end{matrix}$$

A task to optimize an evaluation value E₁ of an evaluation function corresponds to optimization of an evaluation value E₂ of the evaluation formula. It is possible to represent the evaluation formula by a formula (4).

(u₁, . . . , uₙ) is an operation quantity time series.

“Q” is a matrix.

“R” is a vector.

$$\begin{matrix}[ Expression 3 ] & \\ {E}_{2} ( {u}_{1} , … , {u}_{n} ) = \frac{1}{2} ( {u}_{1} , … , {u}_{n} ) Q ( \begin{matrix}{u}_{1} \\ … \\ {u}_{n}\end{matrix} ) + R ( \begin{matrix}{u}_{1} \\ … \\ {u}_{n}\end{matrix} ) & ( 4 )\end{matrix}$$

The evaluation formula generation unit 420 calculates a matrix Q of an evaluation formula and a vector R of the evaluation formula based on the predictive model wherein the matrix A and the vector B are set.

Then, the evaluation formula generation unit 420 sets the matrix Q and the vector R in the evaluation formula. The evaluation formula wherein the matrix Q and the vector R are set is an evaluation formula in quadratic programming.

In the step S330, the solver unit 430 calculates an operation quantity provided to the actuator 311 by solving the evaluation formula in quadratic programming.

Specifically, the solver unit 430 solves the evaluation formula in quadratic programming by executing an optimization solver (quadratic programming solver).

Then, the solver unit 430 provides the operation quantity calculated to the actuator 311.

***Effect of Third Embodiment***

It is possible to obtain the same effect as in the first embodiment also in the model predictive control system 300 to calculate an operation quantity using quadratic programming. That is, it is possible to maintain accuracy of model predictive control even in an unanticipated environment.

***Supplement to Embodiments***

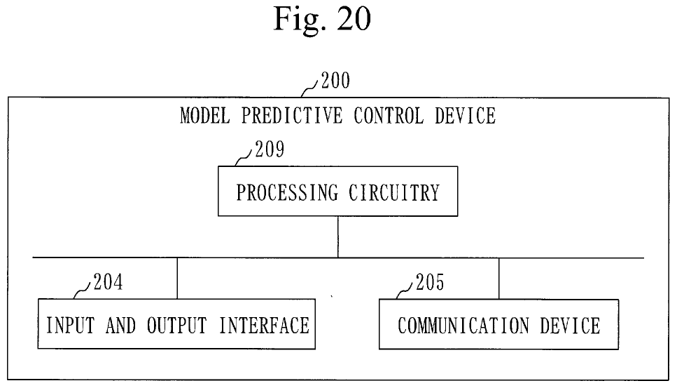

A hardware configuration of the model predictive control device 200 will be discussed based on FIG. 20.

The model predictive control device 200 is equipped with a processing circuitry 209.

The processing circuitry 209 is a hardware component that realizes the operation path generation unit 210, the predictive model unit 220, the neural network unit 230, the state quantity evaluation unit 240 and the learning part 250. The processing circuitry may be a dedicated hardware component, or may be a processor 201 to execute programs stored in the memory 202.

When the processing circuitry 209 is a dedicated hardware component, the processing circuitry 209 is, for example, a single circuit, a composite circuit, a programmed processor, a parallel-programmed processor, an ASIC, an FPGA, or a combination thereof.

ASIC is an abbreviation for “application specific integrated circuit.”

FPGA is an abbreviation for “field programmable gate array.”

The model predictive control device 200 may include a plurality of processing circuits replacing the processing circuitry 209. The plurality of processing circuits share the roles of the processing circuitry 209.

In the model predictive control device 200, a part of the functions may be realized by a dedicated hardware component, and the remaining functions may be realized by software or firmware.

As described above, it is possible to realize the processing circuitry 209 by a hardware component, software, firmware or a combination thereof.

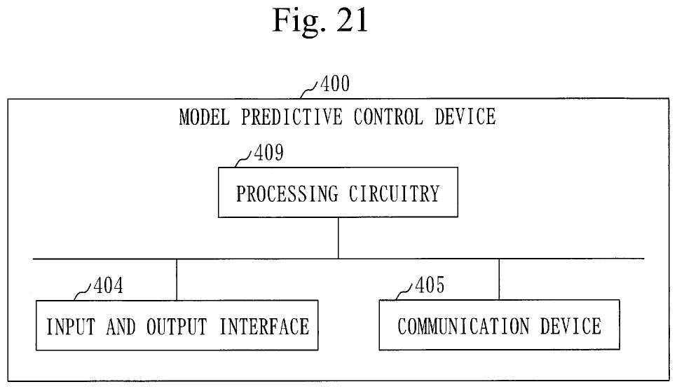

A hardware configuration of the model predictive control device 400 will be discussed based on FIG. 21.

The model predictive control device 400 includes a processing circuitry 409.

The processing circuitry 409 is a hardware component to realize the neural network unit 410, the evaluation formula generation unit 420 and the solver unit 430.

The processing circuitry 409 may be a dedicated hardware component, or may be the processor 401 to execute programs stored in the memory 402.

When the processing circuitry 409 is a dedicated hardware component, the processing circuitry 409 is, for example, a single circuit, a combined circuit, a programmed processor, a parallel-programmed processor, an ASIC, an FPGA, or a combination thereof.

The model predictive control device 400 may include a plurality of processing circuits replacing the processing circuitry 409. The plurality of processing circuits share the roles of the processing circuitry 409.

In the model predictive control device 400, a part of the functions may be realized by a dedicated hardware component, and the remaining functions may be realized by software or firmware.

As described above, the processing circuitry 409 may be realized by a hardware component, software, firmware or a combination thereof.

The present embodiments are examples of preferable embodiments, and are not aimed at limiting a technical range of the present invention. The present embodiments may be partially performed, or may be performed in combination with another embodiment. The procedures described by using flowcharts, etc., may be altered. suitably.

The model predictive control devices (200, 400) may be configured by a plurality of devices. For example, a server device provided on a cloud may include the learning part 250, and the processing of the learning method may be performed on the cloud.

“Unit” being an element of the model predictive control devices (200, 400) may be replaced with “process” or “step.”

### REFERENCE SIGNS LIST

100: model predictive control system; 101: state sensor; 102: environment sensor; 111: actuator; 190: model predictive control system; 191: model predictive control device; 200: model predictive control device; 201: processor; 202: memory; 203: auxiliary storage device; 204: input and output interface; 209: processing circuitry; 210: operation path generation unit; 211: operation quantity time:-series generation unit; 212: operation quantity determination unit; 220: predictive model unit; 230: neural network unit; 231: neural network; 240: state quantity evaluation unit; 250: learning part; 251: model calculation unit; 252: weight parameter teaming part; 280: history unit; 281: state quantity history; 282: environment quantity history; 283: operation quantity history; 284: state quantity learning history; 290: storage unit; 300: model predictive control system; 301: state sensor; 302: environment sensor; 311: actuator; 400: model predictive control device; 401: processor; 402: memory; 403: auxiliary storage device; 404: input and output interface; 409: processing circuitry: 410: neural network unit: 411: neural network; 420: evaluation formula generation unit; 430: solver unit; 490: storage unit

1. A model predictive control device comprising:
processing circuitry to:
generate, based on a measurement state quantity output from a state sensor to measure a state of a controlled object, an operation quantity time series for an actuator in order to make the state of the controlled object change;
generate, by calculating a predictive model by using the measurement state quantity and the operation quantity time series as an input, a state quantity predictive time series being a state quantity time series of prediction of the controlled object;
correct the state quantity predictive time series by performing an arithmetic operation of a neural network, by using, as an input, a measurement environment quantity output from an environment sensor to measure an operating environment of the controlled object, and the state quantity predictive time series;
generate, by calculating an evaluation function by using the state quantity predictive time series after correction as an input, an evaluation result for a state quantity time series after the correction, and
output to the actuator an operation quantity at a head of the operation quantity time series when the evaluation result fulfils an appropriate criterion.

2. The model predictive control device as defined in claim 1,
wherein the processing circuitry generates a state quantity learning time series being a state quantity time series for learning, by calculating the predictive model by using, as an input, a past state quantity being a measurement state quantity output from the state sensor, and an operation quantity past time series being a time series of an operation quantity input to the actuator,
performs machine learning for a weight parameter of the neural network, by using the state quantity learning time series, a past environment quantity being the measurement environment quantity output from the environment sensor, and a state quantity past time series being the time series of the measurement state quantity output from the state sensor, and
performs an arithmetic operation of a neural network wherein the weight parameter obtained by machine learning is set.

3. The model predictive control device as defined in claim 1, wherein the controlled object is a vehicle, the model predictive control device being used for automatic operation control of the vehicle.

4. The model predictive control device as defined in claim 2, wherein the controlled object is a vehicle, the model predictive control device being used for automatic operation control of the vehicle.

5. The model predictive control device as defined in claim 1,
wherein the model predictive control device is a device that provides an operation quantity to an actuator to make a state of a controlled object change, and
wherein the processing circuitry calculates a model parameter that is set in a predictive model to predict a change in the state of the controlled object, by performing an arithmetic operation of a neural network, by using, as an input, a measurement state quantity output from a state sensor to measure the state of the controlled object, and a measurement environment quantity output from an environment sensor to measure an operating environment of the controlled object,
generates an evaluation formula in quadratic programming, as a formula to evaluate an operation quantity time series for the actuator, based on a predictive model wherein the model parameter calculated is set, and
calculates an operation quantity provided to the actuator, by solving the evaluation formula in quadratic programming.

6. The model predictive control device as defined in claim 5, wherein the controlled object is a vehicle, the model predictive control device being used for automatic operation control of the vehicle.

7. A non-transitory computer readable medium storing a model predictive control program to make a computer execute:
an operation quantity time-series generation process to generate, based on a measurement state quantity output from a state sensor to measure a state of a controlled object, an operation quantity time series for an actuator in order o make the state of the controlled object change;
a predictive model process to generate, by calculating a predictive model by using the measurement state quantity and the operation quantity time series as an input, a state quantity predictive time series being a state quantity time series of prediction of the controlled object;
a neural network process to correct the state quantity predictive time series by performing an arithmetic operation of a neural network, by using, as an input, a measurement environment quantity output from an environment sensor to measure an operating environment of the controlled object, and the state quantity predictive time series;
a state quantity evaluation process to generate, by calculating an evaluation function by using the state quantity predictive time series after correction as an input, an evaluation result for a state quantity time series after the correction, and an operation quantity determination process to output to the actuator an operation quantity at a head of the operation quantity time series when the evaluation result fulfils an appropriate criterion.

8. The non-transitory computer readable medium as defined in claim 7,
wherein the model predictive control program is a program to provide an operation quantity to an actuator to make a state of a controlled object change, the model predictive control program to make the computer executing:
a neural network process to calculate a model parameter to be set in a predictive model to predict a change in the state of the controlled object, by performing an arithmetic operation of a neural network, by using, as an input, a measurement state quantity output from a state sensor to measure the state of the controlled object, and a measurement environment quantity output from an environment sensor to measure an operating environment of the controlled object;
an evaluation formula generation process to generate an evaluation formula in quadratic programming, as a formula to evaluate an operation quantity time series for the actuator, based on the predictive model wherein the model parameter calculated is set, and
a solver process to calculate an operation quantity provided to the actuator, by solving the evaluation formula in quadratic programming.

9. A model predictive control system comprising:
a state sensor to measure a state of a controlled object;
an environment sensor to measure an operating environment of the controlled object;
an actuator to make the state of the controlled object change, and
processing circuitry to:
generate, based on a measurement state quantity output from the state sensor, an operation quantity time series for the actuator;
generate a state quantity predictive time series being a state quantity time series of prediction of the controlled object, by calculating a predictive model, by using the measurement state quantity and the operation quantity time series as an input;
correct the state quantity predictive time series, by performing an arithmetic operation of a neural network, by using, as an input, the measurement environment quantity output from the environment sensor, and the state quantity predictive time series;
generate, by calculating an evaluation function by using the state quantity predictive time series after correction as an input, an evaluation result for a state quantity time series after the correction, and
output, to the actuator, an operation quantity at a head of the operation quantity time series when the evaluation result fulfils an appropriate criterion.

10. The model predictive control system as defined in claim 9,
wherein the processing circuitry generates, by calculating the predictive model, by using, as an input, a past state quantity being a measurement state quantity output from the state sensor, and an operation quantity past time series being a time series of an operation quantity input to the actuator, a state quantity learning time series being a state quantity time series for learning,
performs machine learning for a weight parameter of the neural network, by using the state quantity learning time series, a past environment quantity being a measurement environment quantity output from the environment sensor, and a state quantity past time series being a time series of the measurement state quantity output from the state sensor, and
performs an arithmetic operation of a neural network wherein the weight parameter obtained by machine learning is set.

11. The model predictive control system as defined in claim 9, wherein the controlled object is a vehicle, the model predictive control system being used for automatic operation control of the vehicle.

12. The model predictive control system as defined in claim 10, wherein the controlled object is a vehicle, the model predictive control system being used for automatic operation control of the vehicle.

13. The model predictive control system as defined in claim 9,
wherein the processing circuitry calculates a model parameter to be set in a predictive model to predict a change in the state of the controlled object, by performing an arithmetic operation of a neural network, by using, as an input, a measurement state quantity output from the state sensor to measure the state of the controlled object, and a measurement environment quantity output from the environment sensor to measure the operating environment of the controlled object;
generates an evaluation formula in quadratic programming, as a formula to evaluate an operation quantity time series for the actuator, based on the predictive model wherein the model parameter calculated is set, and
calculates an operation quantity provided to the actuator, by solving the evaluation formula in quadratic programming.

14. The model predictive control system as defined in claim 13 wherein the controlled object is a vehicle, the model predictive control system being used for automatic operation control of the vehicle.

15. A model predictive control method, comprising:
measuring a state of a controlled object;
measuring an operating environment of the controlled object;
generating, based on a measurement state quantity output from the state sensor, an operation quantity time series for an actuator to make the state of e controlled object change;
generating a state quantity predictive time series being a state quantity time series of prediction of the controlled object, by calculating a predictive model, by using the measurement state quantity and the operation quantity time series as an input;
correcting the state quantity predictive time series, by performing an arithmetic operation of a neural network by using, as an input, a measurement environment quantity output from the environment sensor, and the state quantity predictive time series;
generating, by calculating an evaluation function by using the state quantity predictive time series after correction as an input, an evaluation result for a state quantity time series after the correction, and
outputting to the actuator an operation quantity at a head of the operation quantity time series when the evaluation result fulfils an appropriate criterion.

16. The model predictive control method as defined in claim 15,
wherein the model predictive control method is a method to provide an operation quantity to an actuator to make a state of a controlled object change, the model predictive control method further comprising:
calculating a model parameter to be set in a predictive model to predict a change in the state of the controlled object, by performing an arithmetic operation of a neural network, by using, as an input, a measurement state quantity output from the state sensor to measure the state of the controlled object, and a measurement environment quantity output from the environment sensor to measure the operating environment of the controlled object;
generating an evaluation formula in quadratic programming, as a formula to evaluate an operation quantity time series for the actuator, based on the predictive model wherein the model parameter calculated is set, and
calculating an operation quantity provided to the actuator, by solving the evaluation formula in quadratic programming.
